(19) United States
(12) Patent Application Publication
(10) Pub. No.: US 2011/0017552 A1
(43) Pub. Date: Jan. 27, 2011

(54) ELEVATOR WITH TWO ELEVATOR CARS AND A COMMON COUNTERWEIGHT

(76) Inventors: Bjarne Lindberg, Adligenswil (CH); Marius Stucheli, Flawil (CH); Josef Husmann, Luzern (CH)

Correspondence Address: FRASER CLEMENS MARTIN & MILLER LLC, 28366 KENSINGTON LANE, PERRYSBURG, OH, 43551, US

(21) Appl. No.: 12/809,785

(22) PCT Filed: Dec. 10, 2008
(86) PCT No.: PCT/EP2008/067178

§ 371 Date: Sep. 22, 2010

(30) Foreign Application Priority Data
Dec. 21, 2007 (EP) 07123998.2

(51) Int. Cl. B66B 11/04

(52) U.S. Cl. 187/257; 187/264

(57) ABSTRACT

A lift comprises a first lift cage, a second lift cage and a counterweight, wherein the counterweight, the first lift cage and the second lift cage are coupled together by way of a support means for lifting and holding, wherein the counterweight, the first lift cage and the second lift cage are additionally coupled together by way of a compensation means and wherein the compensation means runs over at least one deflecting roller. The lift further comprises a brake device for application to the deflecting roller of dissipative braking torque which counteracts the rotation thereof.

### FIELD OF THE INVENTION

The present invention relates to an elevator with a first elevator car, a second elevator car and a counterweight, wherein the counterweight, the first elevator car and the second elevator car are coupled together by way of a support means for lifting and holding, as well as to a method for damping oscillations in such an elevator.

### BACKGROUND OF THE INVENTION

Elevators with two elevator cars and a common counterweight are known from, for example, U.S. Pat. No. 1,837,643, in which the counterweight is arranged in the support means run between the first and second elevator cars and moves in opposite sense to the two elevator cars.

For improvement of the travel characteristics, the counterweight, the first elevator car and the second elevator car are additionally coupled together by way of a compensation means, which is also described in EP 0 619 263 B1 and which in U.S. Pat. No. 1,837,643 runs over three deflecting rollers fixed inertially in a shaft pit and two deflecting rollers arranged at the counterweight.

In order to be able to move the two elevator cars independently of one another a respective own drive is associated with each of them, which drives selectably shorten, keep constant or lengthen the support means length between elevator car and drive and thus raise, hold or lower the respective elevator car.

If one of the elevator cars is at stationary while the other runs, then the compensation means transmits tension force fluctuations of the support means to the stationary elevator car during movement of the other elevator car. As a consequence of the resilient suspension of the stationary elevator car at the support means and the resilience of the support means this leads to undesired oscillations which impair travel comfort and disadvantageously load, in alternating manner, the components of the elevator, particularly the support means, in the fastenings thereof and the suspensions of the elevator car.

### SUMMARY OF THE INVENTION

It is therefore an object of the present invention to reduce such loads.

An elevator according to the invention comprises at least one first and second elevator car as well as a counterweight, which are coupled together by way of a support means for the lifting or holding. The counterweight can be arranged, in particular, in the support means run between the first and the second elevator car and move in opposite sense to the sum of the sign-bearing speeds of the two elevator cars. For example, it lowers when one of the first and second elevator cars is raised and the other of the first and second elevator cars is similarly raised or is stationary. Thereagainst, the counterweight rises, for example, when one of the first and second elevator cars is lowered more rapidly than the other of the first and second elevator cars is raised. The first and second elevator cars can preferably move in the same elevator shaft adjacent to one another or one above the other, wherein in the latter case an elevator control advantageously prevents collision of the two elevator cars.

The counterweight, the first elevator car and the second elevator car are additionally coupled together by way of a compensation means. The support and/or compensation means can comprise, for example, one or more metal or synthetic fiber cables with optional sheathings, belts with sheathed tensile carriers of metal or synthetic material fibers or the like and runs over at least one deflecting roller so as to advantageously enable an inertial coupling, a common use of the counterweight and a division, in the manner of a block-and-tackle, of the tension forces.

According to the invention the elevator further comprises at least one brake device for application of a braking torque to the deflecting roller, which counteracts a rotational movement of the deflecting roller and dissipatively breaks down the energy of rotation transmitted by the compensation means to the deflecting roller.

If the tension force in the support means now fluctuates, for example on acceleration or braking of one elevator car while the other elevator car is stationary, this imposes, in the compensation means, tension force fluctuations and micro-movements which lead, particularly in conjunction with a resilient suspension, to oscillations of the elevator cars and the counterweight. The braking torque, which acts in braking manner on the deflecting roller over which the compensation means runs, has a damping effect on such oscillations, which advantageously reduces oscillation-induced loads of the elevator components.

The elevator shall operate as efficiently in terms of energy as possible. In a preferred embodiment of the present invention the brake device is therefore selectably adjustable between a released setting, in which it exerts on the deflecting roller only a small or no braking torque, and an applied setting, in which it applies a greater braking torque. As a result, oscillations which occur can be damped appropriately to need by the dissipatively acting braking torque of the applied brake device, whilst the released brake device advantageously consumes little or no energy when no oscillations are to be damped.

In particular, the brake device can be so constructed that it applies a dissipative braking torque to the at least one deflecting roller when one of the first and second elevator cars is stationary and the other of the first and second elevator cars moves, since in this case changes in tension force particularly lead to oscillations at the moving elevator car. If, thereagainst, the first and second elevator cars both move or are at standstill, the brake device is advantageously released, since in this case less oscillations are induced.

For preference, the braking torque applied by the brake device to the deflecting roller is settable, in particular regulable. The brake device can, for example, be controlled or regulated by an elevator control. Thus, the applied braking torque can be optimally adapted and, for example, increased in the case of stronger oscillations so as to more strongly damp these. Advantageously such a settable brake device can also act in assisting manner in the event of an emergency stop of an elevator car, for example a safety braking of the elevator car by safety brakes in the case of failed support means.

If the compensation means runs over several deflecting rollers each co-operating with a brake device, the individual brake devices can advantageously be subject to different control or regulation. For example, the deflecting roller at a stationary elevator car can be applied and counteract, in damping manner, tension force fluctuations occurring there, whilst at the same time a deflecting roller at a moving elevator car and/or a counterweight moving as a consequence thereof is released so as to not prevent the rotation of the deflecting rollers required for that purpose.

The overall speed of the compensation means at which this runs over a deflecting roller is composed of a fundamental component, which results from the movement of elevator car or counterweight, and a component of changing sign which is superimposed thereon and which results from the oscillations usually of high frequency. The brake device is therefore preferably so constructed that the braking torque applied by it to the deflecting roller is dependent on the rotational speed of the deflecting roller, in particular increases, for example substantially proportionally, with rising rotational speed. As is known, speed-proportional forces or torques, which counteract a movement, damp oscillations with particular efficiency and stability, since the higher speed components resulting from oscillations are more strongly damped, whilst a constant fundamental speed of the brake device functioning as a low-pass filter is influenced only slightly.

For this purpose the brake device can comprise a damper, particularly a hydraulic, pneumatic, mechanical or magnetic damper.

Thus, the brake device can comprise, for example, a fluid roller damper which is connected with the axle of the deflecting roller directly, by way of a transmission and/or by way of a clutch. Such a roller damper generally comprises a fluid pump, which is driven by the deflecting roller and pumps a fluid, for example—in the case of a hydraulic roller damper—a hydraulic fluid such as, for example, oil through a circuit in which a valve is arranged. In that case a gas can also be used as fluid and thus a pneumatic damper can be formed.

In order to dissipate as little energy as possible when the brake device is released the fluid circuit is then advantageously constructed to be low in friction.

Energy is dissipated at the valve due to flow, especially throttling, losses. Advantageously the valve can in that case be adjusted, for example continuously or in discrete steps, whereby the losses due to throttling and thus the dissipated energy can be set. If the valve is closed to a greater degree, the fluid pump circulating the fluid counteracts a higher flow resistance. This increases with higher speeds of the deflecting roller and the pump, which is connected therewith, as well as of the fluid circulated by this, so that it is possible to realize, by an adjustable valve, a settable damping constant of a speed-proportional damping, which is advantageously adaptable to different elevator types or operational states, for example the loads and/or positions of the elevator cars. Thus, for example, the damping constant can be reduced for heavier elevator cars with low natural frequencies.

The brake device can, through complete closing of the valve, advantageously function as a (additional) holding or parking brake.

Additionally or alternatively the brake device can comprise, for example, a fluid rotation brake which is connected with the axle of the deflecting roller directly, by way of a transmission and/or by way of a clutch. Such a rotation brake operates according to the principle explained in the foregoing, wherein instead of the valve a throttle device is arranged in the fluid circuit, which throttle device by virtue of its flow resistance gives a speed-dependent braking torque rising with the rotational speed of the fluid pump and thus the rotational speed of the deflecting roller connected therewith. Advantageously, such a throttle does not require any external energy for actuation, but can operate autonomously and automatically.

Additionally or alternatively the brake device can comprise, for example, a centrifugal force brake which is connected with the axle of the deflecting roller directly, by way of a transmission and/or by way of a clutch. Such a centrifugal force brake can, for example, act mechanically and comprises for this purpose one or more friction linings which moves or move radially outwardly under a centrifugal force acting thereon and exerts or exert a braking torque on a brake bell. As in the case of the afore-described rotation brake such a centrifugal force brake advantageously operates without external feed of energy and provides a speed-dependent braking torque for oscillation damping. In that case a breakaway speed, at which braking torque is built up the first time, as well as the dependence of the braking torque on the rotational speed of the deflecting roller can be set by way of, for example, the spring hardness and/or bias of restoring springs acting against the centrifugal force, the masses of the friction linings or the like.

Whereas a brake device constructed as a fluid roller damper can preferably be released by opening the valve, in the case of a fluid rotation brake or centrifugal force brake, which automatically operate in speed-dependent manner, the braking device can for this purpose be advantageously separated from the deflecting roller by way of a clutch when, for example, both elevator cars move and the brake device is not to apply any braking torque to the deflecting roller. The deflecting roller thereby advantageously rotates in a low-friction manner.

In a further preferred embodiment the brake device comprises an oscillation damper. This generally comprises a damping mass coupled with the deflecting roller by way of a spring-damper arrangement so as to be capable of oscillation. Natural frequencies can be achieved by this coupling, in particular displaced into rotational speed ranges not occurring or seldom occurring in operation. Disturbing oscillations in specific frequency ranges are thereby damped. This system also advantageously operates without external feed of energy and to be low in friction in stationery operation. In addition, an oscillation damper can in a preferred embodiment and as described in the foregoing be separated from the deflecting roller by way of a clutch.

The brake device can also comprise a controllable or regulable brake, the braking torque of which can be controlled or regulated substantially independently of the rotational speed, for example a mechanical friction brake such as a drum brake or shoe brake, but also an electromagnetic eddy current brake. Through selectable application and release of such a brake it is similarly possible to damp oscillations, but in addition a low-friction operation can be realized. Such brakes can, for example, be actuated by an elevator control, particularly an elevator car control.

The brake device can be coupled with the deflecting roller directly, by way of a transmission and/or by way of a clutch, so that the brake device operates in favorable rotational speed ranges or can be decoupled for reduction of losses.

The compensation means can run over several deflecting rollers. For example, it can run over one or more deflecting rollers arranged at the counterweight, one or more deflecting rollers inertially fixed in a shaft of the elevator, particularly in a shaft pit, and/or one or more deflecting rollers connected with a tensioning device, particularly a tensioning weight. It is thereby possible, for example, for the first and/or second elevator car to be suspended with a 1:1 ratio and/or the counterweight in a 2:1 ratio at the compensation means so that the counterweight moves by comparison with an elevator car over half the travel path. With particular preference the first and/or second elevator car can be suspended at the support means with a 1:1 ratio and/or the counterweight can be suspended at the support means with a 2:1 ratio, so that the suspension at the support and compensation means advantageously correspond with one another.

If the compensation means runs over several deflecting rollers, preferably two or more deflecting rollers can each co-operate with a respective brake device, which is constructed for application to this deflecting roller of a dissipative braking torque counteracting rotation thereof, as was described in the foregoing, wherein the individual braking devices can be of the same construction or different from one another in dimension, adjustment or principle of operation. Thus, for example, a brake device, which co-operates with a deflecting roller at the counterweight rotating not only when the first elevator car is stationary and the second elevator car is moving, but also when the first elevator car is moving and the second elevator car is stationary, can be constructed to be particularly low in friction, i.e. a brake device, which co-operates with a deflecting roller at an elevator car, with an additional holding function.

As expressed in the foregoing, such brake devices can advantageously be controlled in drive in a different manner. By way of example, through, for example, at least partial closing of a valve of a fluid roller damper, coupling of a rotation or centrifugal force brake, or applying a controllable or regulable mechanical brake, it is possible to exert a braking torque on a deflecting roller, which is connected with the elevator car, when this elevator car is at standstill so as to damp oscillations which are communicated to the stationary elevator car by another, moving elevator car via the compensation means and the deflecting roller. Conversely, by, for example, at least partial opening of a valve of a fluid roller damper, decoupling of a rotation or centrifugal force brake, or release of a controllable or regulable mechanical brake, the energy dissipated in this deflecting roller can be reduced when this elevator car moves.

### DESCRIPTION OF THE DRAWINGS

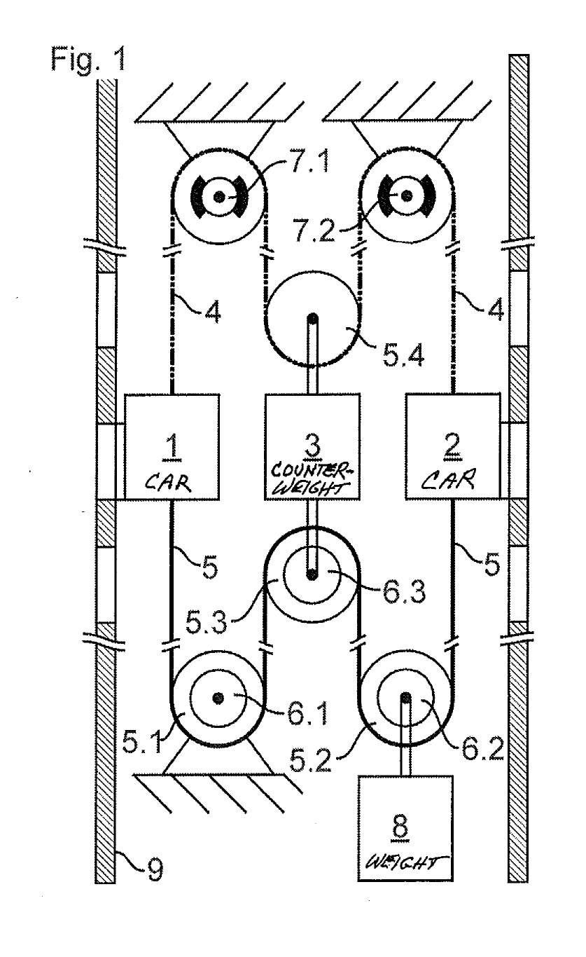

Further features and advantages are evident from the following example of embodiment. For this purpose the single FIG. 1 shows, partly schematically, an elevator according to an embodiment of the present invention.

### DESCRIPTION OF PREFERRED EMBODIMENTS

FIG. 1 shows in lateral cross-section an elevator according to an embodiment of the present invention with a first elevator car 1 and a second elevator car 2.

The two elevator cars are coupled together by way of a support means in the form of a belt 4, which runs in the same sense over a first drive pulley of a first drive 7.1 for the first elevator car and a second drive pulley of a second drive 7.2 for the second elevator car. A first or second electric motor of the first or second drive 7.1 or 7.2 can apply a torque to the first or second drive pulley so as to raise, hold or lower the first or second elevator car 1 or 2. The elevator cars 1, 2 arranged adjacent to one another in an elevator shaft 9 can thereby move independently of one another.

The support means 4 runs between the two drives 7.1, 7.2 in opposite sense around a deflecting roller 5.4 at which a counterweight 3 is suspended, so that the first and second elevator cars 1, 2 are suspended in a 1:1 ratio, and the counterweight 3 in a 2:1 ratio, at the support means 4, i.e. the support means lowers in the ratio 1:2 when the first or second elevator car 1 or 2 is raised, and vice versa.

A compensation means in the form of a belt 5 is attached to the underside of the first and second elevator cars 1, 2. The compensation means runs, starting from the first elevator car 1, around a first deflecting roller 5.1 mounted inertially in the shaft pit of the elevator shaft 9, subsequently loops in opposite sense around a third deflecting roller 5.3 fastened to the underside of the counterweight 3, runs from there again in opposite sense around a second deflecting roller 5.2, at which a compensating means tensioning device in the form of a tensioning weight 8 is suspended, and is fastened at its other end to the underside of the second elevator car 2. The elevator cars 1, 2 are thus suspended in a 1:1 ratio, and the counterweight 3 in a 2:1 ratio, at the compensation means 5 in corresponding manner in the support means suspension.

If, for example, the second elevator car 2 is now stopped at a floor, in that the second drive 7.2 blocks rotation of the second drive pulley, whilst at the same time the first drive 7.1 raises the elevator car 1, the counterweight 3 simultaneously sinks by half the travel path. In that case the compensation means 5 is drawn in by the rising first elevator car 1 and in that case runs over the co-rotating first and third deflecting rollers 5.1 and 5.3. Torque fluctuations of the first drive 7.1, adhesion/sliding transitions of the first elevator car 1, tension force fluctuations, which are caused by inertia and resilience, in the support means 4 and the like have the consequence that the first elevator car 1 exerts a non-uniform tension force on the compensation means 5, which due to the resilient suspension of the second elevator car 2 at the resilient support means 4 leads to undesired fluctuations, particularly of the stationary second elevator car 2.

A second brake device in the form of a hydraulically regulable roller damper 6.2 is therefore provided, which is connected by way of a pinion with the second deflecting roller 5.2 and comprises a hydraulic pump, which is driven by the deflecting roller 5.2, as well as a valve actuable by an elevator control (not illustrated). If the second elevator car 2 is at standstill, the valve of the hydraulically regulable roller damper 6.2 is partly closed. The thereby-induced flow resistance of the oil circulated in a hydraulic circuit by the hydraulic pump produces a dissipative braking torque on the second deflecting roller 5.2, which opposes rotation thereof. This braking torque is proportional to speed and thus damps oscillations transmitted by the compensation means 5 running over the second deflecting roller 5.2. Through different degrees of opening of the valve the damping coefficient can in that case be advantageously adapted to different ambient conditions, for example different weights of the elevator cars, of the compensating means or the like.

If, thereagainst, the second elevator car 2 is to move, the elevator control releases the second brake device 6.2 in that it fully opens the valve. The flow resistance and thus the braking torque acting on the second deflecting roller 5.2 are thereby strongly reduced so that only a small amount of energy is dissipated in travel operation.

The first deflecting roller 5.1 is also connected in corresponding manner with a first brake device 6.1, which is constructed analogously to the afore-described second brake device 6.2.

In an alternative embodiment (not illustrated) of the present invention the second brake device 6.2, which moves freely with the tensioning weight 8, is constructed as a mechanical centrifugal force brake which is self-actuating, i.e. exerts, without external energy supply or actuation, on the deflecting roller 5.2 a braking torque which increases with rising rotational speed of the second deflecting roller 5.2 and counteracts the rotation. The first braking device 6.1, which co-operates with the first deflecting roller 5.1 inertially mounted in the elevator shaft 9 and therefore is simply to be supplied with external energy and to be controlled in drive by the elevator control, is constructed as a regulable brake, which is applied, to at least be dragging, when the first elevator car 1 is stationary and is released when the first elevator car 1 is moving, and thus dissipatively damps oscillations of the compensating means 5 on the stationary first elevator car 1.

The counterweight 3 moves not only when the first elevator car is moving and the second elevator car stationary, but also when the first elevator car is stationary and the second elevator car is moving. A third brake device 6.3 in the form of an oscillation damper is therefore connected with the third deflecting roller 5.3 arranged at the underside of the counterweight 3. For this purpose a damping mass is connected with the third deflecting roller 5.3 by way of a torsion spring and damper arrangement (not illustrated). The spring or damper constant as well as the damping rotary mass in that case are so matched that oscillations occurring in operation are preferentially damped in the compensating means 5. Advantageously, in the case of constant oscillation-free running this oscillation damper does not dissipate any energy and damps oscillations, which arise on the other side, in a compensating means 5 without external energy supply or actuation.

Autonomous braking devices or braking devices which are controllable or regulable can be arranged at one or more deflecting rollers over which the compensation means 5 runs, which braking devices can apply to the respective deflecting roller a preferably speed-dependent and/or settable braking torque so as to damp oscillations in the compensating means. In that case braking devices of different or identical construction, which are preferably individually controllable in drive, particularly able to be released and applied, can be provided at different deflecting rollers.

In accordance with the provisions of the patent statutes, the present invention has been described in what is considered to represent its preferred embodiment. However, it should be noted that the invention can be practiced otherwise than as specifically illustrated and described without departing from its spirit or scope.

1-17. (canceled)

18. An elevator having a first elevator car, a second elevator car and a counterweight coupled together by a support means for the lifting and holding, and the counterweight, the first elevator car and the second elevator car additionally coupled together by a compensation means, comprising:
at least one deflecting roller engaged by the compensation means; and
a brake device for applying to said at least one deflecting roller a braking torque which counteracts rotation of said at least one deflecting roller.

19. The elevator according to claim 18 wherein said brake device is selectably adjustable between a released setting with no braking torque applied and a braking torque applied setting.

20. The elevator according to claim 18 wherein said braking device is settable for regulating the baking torque applied to said at least one deflecting roller.

21. The elevator according to claim 18 wherein the braking torque applied to said at least one deflecting roller by said brake device is dependent on a rotational speed of the deflecting roller, increasing with increasing rotational speed.

22. The elevator according to claim 18 wherein said brake device is one of an hydraulic damper, a pneumatic damper, a mechanical damper and a magnetic damper.

23. The elevator according to claim 18 wherein said brake device is an oscillation damper.

24. The elevator according to claim 18 wherein said brake device is coupled with said at least one deflecting roller directly or by a transmission.

25. The elevator according to claim 18 wherein said compensation means engages at least two of said deflecting roller, each of said at least two deflecting rollers co-operating with a respective one of said brake device for application of a dissipative braking torque which counteracts rotation of said at least two deflecting rollers.

26. The elevator according to claim 18 wherein said at least one deflecting roller is attached to the counterweight.

27. The elevator according to claim 18 wherein said at least one deflecting roller is fixed in a shaft pit of the elevator.

28. The elevator according to claim 18 wherein said at least one deflecting roller is attached to a tensioning device.

29. The elevator according to claim 18 wherein the first and second elevator cars are movable independently of one another.

30. The elevator according to claim 18 including a first drive for lifting or holding the first elevator by the support means and a second drive for lifting or holding the second elevator car by the support means, at least one of the first and second elevator car being suspended with a 1:1 ratio, and the counterweight being suspended with a 2:1 ratio.

31. An elevator comprising:
a first elevator car associated with a first drive;
a second elevator car associated with a second drive;
a counterweight positioned in an elevator shaft with said first elevator car and said second elevator car;
a support means for the lifting and holding said counterweight, said first elevator car and said second elevator car, said support means having one end attached to said first elevator car and an opposite end attached to said second elevator car;
a compensation means having one end attached to said first elevator car and an opposite end attached to said second elevator car;
a first deflecting roller mounted in the elevator shaft;
a second deflecting roller attached to a tensioning weight;
a third deflecting roller and a fourth deflecting roller each attached to said counterweight, said support means engaging in sequence said first drive, said fourth deflecting roller and said second drive, and said compensation means engaging in sequence said first deflecting roller, said third deflecting roller and said second deflecting roller; and
a separate brake device associated with each of said first deflecting roller, said second deflecting roller and said third deflecting roller for applying to said associated deflecting roller a braking torque which counteracts rotation of said associated deflecting roller.

32. A method of damping oscillations transmitted by a compensation means from a moving elevator car to a stationary elevator car of an elevator wherein the moving elevator car and the stationary elevator car are coupled by the compensating means, comprising the steps of:
providing at least one deflecting roller engaging the compensating means; and
applying a dissipative braking torque counteracting rotation of the at least one deflecting roller using a brake device.

33. The method according to claim 32 including releasing or reducing the dissipative braking torque when the stationary elevator car moves.
